(19) United States
(12) Patent Application Publication
(10) Pub. No.: US 2005/0099150 A1
(43) Pub. Date: May 12, 2005

(54) Door control apparatus and method

(76) Inventor: Scott Nicholson, Saratoga (AU)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/985,280

(22) Filed: Nov. 10, 2004

(30) Foreign Application Priority Data
Nov. 10, 2003 (AU) 2003906168

(51) Int. Cl. H02P 3/00

(52) U.S. Cl. 318/469

(57) ABSTRACT

Roller door control apparatus including a AC driving motor, a door travel distance sensor, a micro processor and associated memory apparatus adapted to receive information concerning on/off status of the driving motor as well as door position information; driving motor control means responsive to information stored in the memory apparatus adapted to cut power to the motor in advance of the door reaching a desired limit; the information comprising an estimate of the distance which the door will ran-on after power is cut to its driving motor; the estimate being based upon the run-on experienced after power was cut to the motor driving the door in the previous travel cycle in the same direction or other prior travel cycles in the same direction and stored in the memory apparatus.

### FIELD OF THE INVENTION

The present invention relates to apparatus and a methodology for controlling the position at which a AC motor driven door stops and which takes into account creep in door position which occurs after power is cut to the driving motor.

### BACKGROUND OF THE INVENTION

For many years both domestic and industrial doors have been driven by a simple electric motors and limit switches have been provided in order to stop the driving motors when the door reaches either its lowermost shut position or its upper most open position.

Unfortunately doors are heavy and simply cutting power to the driving motor does not ensure that the door will immediately stop. Particularly in the case of heavy industrial doors a door will maintain momentum after power is cut to the driving AC motor and the door consequently travels a significant distance after the power to the motor is cut. With DC motors the speed of the door when approaching a desired limit can be reduced by reducing voltage supplied but with an AC motor speed control is not so simply achievable This can result in doors slamming into concrete at their lower most extent of travel and overshooting their intended upper limit. Limit switches can be set to accommodate a level of creep or run-on which is observed or anticipated at a particular point in time in order to try and overcome the above-mentioned difficulty but this creep or run-on of doors is a function of friction within the door and guide track system and this friction can change significantly from day to day or even hour to hour with temperature and humidity variations and furthermore this friction changes significantly over the life of the door due to wear in the various components.

Variable speed drives and braking systems can be utilised to overcome the difficulties associated with creep or run-on but these solutions involve significantly more expensive motors and other componentry. It is consequently an object of the present invention to ameliorate one or more of the above difficulties associated with bringing AC motor driven roller doors to a stop at a predetermined position or at least to provide the market with an alternative.

### SHORT SUMMARY OF THE INVENTION

According to the present invention there is provided roller door control apparatus including an AC driving motor, a door travel distance sensor, a micro processor and associated memory apparatus adapted to receive information concerning on/off status of the driving motor as well as door position information; driving motor control means responsive to information stored in the memory apparatus adapted to cut power to the motor in advance of the door reaching a desired limit; the information comprising an estimate of the distance which the door will run-on after power is cut to its driving motor; the estimate being based upon the run-on experienced after power was cut to the motor driving the door in the previous travel cycle in the same direction or other prior travel cycles in the same direction and stored in the memory apparatus.

### BRIEF DESCRIPTION OF THE DRAWINGS

One embodiment of the present invention will now be described with reference to the accompanying drawings in which:

FIG. 1 is an end elevation of a chopper wheel being part of the door position sensing apparatus of the present invention and;

FIG. 2 is a top plan view of a chopper wheel and associated optical apparatus being part of the door position sensing a apparatus of the present invention.

### PREFERRED MODE OF CARRYING OUT THE INVENTION

The depicted embodiment relates to a roller door driven by a non variable speed AC motor with simple on off control and no braking facility. The term roller door as used in this patent specification includes all doors or gates which have door panels or curtains which are driven up and down or side to side utilising drive mechanisms which include rotating shafts. These shafts are sometimes concentric with a drum about which the door panel or curtain is stored or alternatively such shafts may support a counterbalance spring and a pulley on the shaft may be connected to the door via cables. In all such cases the rotation of such shafts, whether directly driven by a motor or whether otherwise connected to the door, rotate for a particular number of revolutions or part revolutions in a fixed ratio to the distance travelled by the door.

According to the depicted embodiment of the present invention such a shaft 1 may carry a reference wheel (such set being hereafter referred to as a “chopper” wheel) 2 which in turn is provided with a number of (in this case twenty but only two of which are shown) slots 3 radially spaced from each other around the periphery of the wheel. The purpose of the slots is to facilitate the chopper wheel 2 comprising part of an optical infra-red rotary position sensing mechanism involving an infra-red transmitter and receiver set (hereinafter referred to as an interruptor) adapted to pass infra-red light through the slots.

If the interrupter 4 is set up as depicted in FIG. 2 then an infra-red beam 5 will be capable of passing through the wheel 2 only when a slot is aligned between the infra-red transmitter 6 and infra-red receiver 7 are aligned with a slot 3. As the chopper wheel rotates the infra-red receiver will therefore receive a pulse of infra-red light each time a slot passes through the beam. The infra-red receiver converts these I-R pulses to electronic pulses and then transmits these electronic pulses in real time to a micro processor (not shown) which may then calculate the distance that the door has travelled based upon a known ratio between door travel distance and angular rotation of the chopper wheel for any given (and known) length of door wound about the drum.

The door position may also be determined by the micro processor provided information is input into the micro processor concerning initial door position and direction of travel. If the microprocessor is also in communication with a sensor (not shown) indicating the on/off status of the motor (not shown) driving the door then the micro processor may additionally calculate the distance which the door travels after power to the motor it is cut. The microprocessor is therefore capable of calculating a creep or run-on value associated with the door.

This run-on distance calculated by the micro processor may be stored in a memory device (not shown) and then used by the micro processor to control the position at which the door stops in its next operational cycle. As the door position at any time and the limit positions are stored in the memory device the micro processor simply cuts power to the motor driving the door when the door reaches a point which is short of a desired limit by the distance equal to the run-on value communicated to the memory device and stored therein during the previous operating cycle.

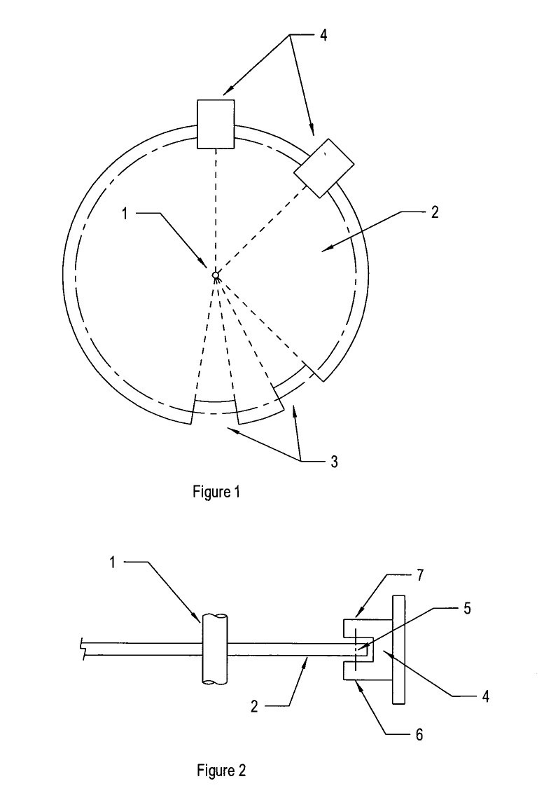

Of course the run-on or creep of a particular door is likely to be different according to the direction of travel of the door and hence it is desirable, as depicted in FIG. 1, that two interrupters 8 and 9 be provided so that by determining which interrupter receives a signal from a given slot first the microprocessor can determine the direction of travel of the door and hence be capable of storing both a run-on value for the opening cycle of the door and a separate and different run-on value for used with the closing cycle of the door. For this purpose it is desirable that the configuration of the interrupters or other devices inputting to the micro processor be capable of indicating the direction of rotation of the chopper wheel.

In order to maximise sensitivity the slots in the chopper wheel should be larger than the aperture of the IR beam receiver. Since the slot width is calculated by dividing the perimeter at the optical radius of the chopper wheel by twenty (since there are twenty slots) increasing the slot width will result in an increase in diameter of the chopper wheel.

A typical beam aperture is 1.5 mm wide by 2 mm high with the beam being narrower in the direction tangential to the direction of the rotation. In order for both the beams to clear the edges of a slot it is desirable for the slot to be a minimum of 3 mm wide (i.e. two aperture widths). However at this width the output signal at the receiver has a significant rise and fall time due to the slow tangential velocity of the slot if the wheel diameter is small (say less than 360 mm). It is therefore desirable that the slot be slightly wider than above mentioned, say 9 mm wide, in order to increase the tangential velocity of the wheel and thereby obtain sharper resolution of the slot edge. As a result the chopper wheel in the above example should have a circumference of 360 mm or greater at the optical radius. The optical radius should therefore desirably not be less than 57 mm. It is assumed that the chopper wheel rotates at a rate of approximately 32 rpm.

In order to maintain a long and reliable service life it is desirable that the chopper wheel and interrupters be encased in a dust proof enclosure.

It will be appreciated that alternative embodiments of the above invention may be devised without departing from the scope and internment of the present invention and for example door travel sensors other than the interrupters above described may be utilised.

1. Door or gate control apparatus including an AC driving motor, a door travel distance sensor, a rotating shaft in the drive mechanism, a micro processor and associated memory apparatus adapted to receive information concerning on/off status of the driving motor as well as door position information; driving motor control means responsive to information stored in the memory apparatus adapted to cut power to the motor in advance of the door reaching a desired limit and in accordance with information stored in the memory apparatus comprising an estimate of the distance which the door or gate will run-on after power is cut to its driving motor; the estimate being based upon the run-on experienced after power was cut to the motor driving the door or gate in the previous travel cycle in the same direction or multiple prior travel cycles in the same direction and stored in the memory apparatus; the door travel distance sensor including a reference wheel attached to the rotating shaft and provided with a multiplicity of slots; an optical projection device and an optical receiving device disposed either side of the slots; the arrangement of the optical projection device and the optical receiving device being such that the receiving device will receive light from the projecting device each time a slot passes between the projecting device and the receiving device.

2. Control apparatus in accordance with claim 1 hereof wherein the optical projection device is an infra-red projection device; the arrangement of the infra-red projection device and the optical receiving device being such that the receiving device will receive light from the projecting device each time a slot passes between the projecting device and the receiving device; the receiving device configured to transmit an electronic pulse to the microprocessor each time it receives an infra-red light pulse.

3. Control apparatus in accordance with claim 1 hereof wherein there are two door travel distance sensors in order that by determining which sensor receives a signal from a given slot in the reference wheel first the microprocessor can determine the direction of travel of the door without independent information from the motor concerning the direction of travel.

4. Control apparatus in accordance with claim 1 hereof wherein the memory apparatus stores information concerning distance traveled after motor shut down with the door traveling in a closing direction separately from information concerning distance traveled by the door when the door is traveling in an opening direction.

5. Control apparatus in accordance with claim 1 hereof wherein the door is driven by a non-variable speed motor with simple on/off control and no braking facility.

6. Control apparatus in accordance with claim 1 hereof wherein the reference wheel and sensors are encased in a dust proof enclosure.

7. Control apparatus in accordance with claim 1 hereof wherein the slots in the reference wheel are larger along the line tangential to the wheel perimeter than the aperture of the optical receiving device.

8. Control apparatus in accordance with claim 1 hereof wherein the slots in the reference wheel at least twice as large along the line tangential to the wheel perimeter than the aperture of the optical receiving device.
